(19) United States
(12) Patent Application Publication
(10) Pub. No.: US 2006/0180267 A1
(43) Pub. Date: Aug. 17, 2006

(54) Zero gap decoration integration by negative vacuum forming

(76) Inventor: Dominque Duriez, Annoeullin (FR)

Correspondence Address: VISTEON, C/O BRINKS HOFER GILSON & LIONE, PO BOX 10395, CHICAGO, IL, 60610, US

(21) Appl. No.: 11/335,257

(22) Filed: Jan. 19, 2006

(30) Foreign Application Priority Data
Jan. 19, 2005 (FR) FR 0500535

(51) Int. Cl. B29C 65/00; B29D 31/00

(52) U.S. Cl. 156/196; 156/242

(57) ABSTRACT

A composite part is manufactured having at least two different appearances and/or feels in at least two surface. A localized deformation in the form of a groove in the skin is provided at each interface between the two surface zones and one of the surface zones is recessed in relation to the other zone. The recessed surface zone is displaced to bring the ridge of this zone flush with the corresponding ridge of the adjacent or contiguous surface zone. This confers on the skin its final form, and then duplicate molding on the internal face of the skin is performed to produce the composite part.

### BACKGROUND

1. Technical Field of the Invention

The present invention relates to the field of the manufacture of parts or sections made of synthetic materials, particularly composite parts, and relates to a manufacturing process for a composite part comprising at least two different feels or surface appearances, and also a part obtained from such a process.

2. Description of Prior Technology

In the field of apparent elements and visible surface systems, particularly in automotive vehicles, such as for example trimming or interior covering parts or consoles in the interior of the vehicle, there is currently a very strong demand for improvements to the finish and aesthetic quality, particularly when additional components must closely fit the level of the surrounding surfaces on which they are fixed.

The solution chosen and generally implemented at present consists of creating an interstice or groove, with a width that, far as possible, is constant over its length, to separate the different functions and hide the limit between two appearances, colors, feels and materials.

There must be a minimum interstice if such elements or surface systems are produced by assembling a plurality of parts or components, which is not the case at present due to the manufacturing tolerances of the different parts and components.

In fact, in the solution traditionally chosen the different sections or additional components are manufactured separately from the main section and assembled therewith by means of an intermediate component. This intermediate component may be, for example, a ventilation outlet or a compartment and the main section may be an instrument panel, a console, a door panel or other elements of the interior upholstery of a car. These components introduce special decorations round the functional system, assembly or fixing being performed by screwing or clipping in a supplementary operation.

The residual interstice between the components and the main section depends on the manufacturing tolerances thereof and the assembly tolerances. It is therefore difficult with traditional solutions to guarantee a regular interstice around the components and the main section and non-critical adjustment or a limit reduced to a line.

FIG. 1 illustrates the known solution consisting of incorporating a special aspect or decoration and the main aspect in the same material. The limit between the two aspects may be hidden at the bottom of a groove which is constant, because it is formed by a tool.

FIGS. 2A, 2B and 2C illustrate another technological solution used to reduce the interstice formed by the groove, when the geometry allows this. As shown in FIG. 2B, the skin includes a groove that separates the two appearances, by hiding their respective limits or ends. This groove is reduced in width in a forming tool by bringing together the two zones of different appearance using mechanical means (see FIG. 2C—a view in section along A-A the finished part of FIG. 2A). This solution does not however guarantee complete reduction of the interstice to a simple line and is only suited to linear grooves.

Thus, one object of the present invention is to overcome the various aforementioned and other drawbacks.

### SUMMARY

Accordingly, the present invention relates to a manufacturing process for a composite part having at least two different appearance and/or feels in the region of at least two directly adjacent or contiguous apparent surface zones. The part includes a thermoplastic skin, of which one side forms the external and apparent face of said part, and a material covering the internal side of the skin and forming the body of said part.

The process basically consists of providing a skin with at least two different appearances and/or feels in the region of the surface zones concerned. A localized deformation, in the form of a groove or recess of said skin, is provided at each interface between the two surface zones of different appearance and/or feel, with each deformation defining ridges in the region of the edges opposite each pair of adjacent or contiguous surface zones. One of the zones of each pair of zones is situated so as to be set back from the other adjacent contiguous zone of that pair. The treated and preformed skin is located in a duplicate molding mold and each recessed surface zone is acted upon to displace it to bring, and optionally maintain, each ridge of this zone substantially in contact and flush with the corresponding ridge opposite the adjacent or contiguous surface zone, thus conferring on the skin its final form. The mold is thereafter closed and the skin is duplicated on the opposite side on the external face, and maintained as such until the duplicate molding material is sufficiently set or solidified to retain the final form of the skin. Finally, the resulting composite part is removed from the mold.

### BRIEF DESCRIPTION OF THE DRAWINGS

The invention will be better understood, using the description below, which relates to a preferred embodiment, given as a non-limiting example, and explained with reference to the accompanying diagrammatic drawings, in which:

FIG. 1 is a cross-sectional view of a prior art composite part;

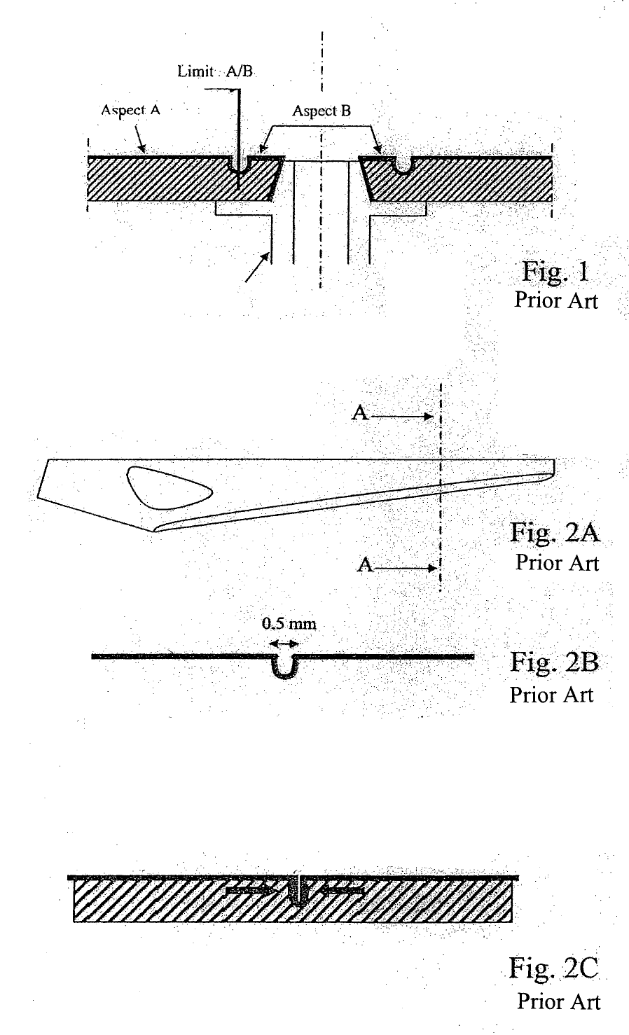

FIGS. 2A-2C are cross-sectional views of a prior art composite part at various stages of constructions;

FIGS. 3A-3C are partial cross-sectional views illustrating three stages of a process embodying the principles of the present invention; and

FIGS. 4A-4F diagrammatically illustrate the preforming stages of a skin that is to form part of a composite part according to the principles of the present invention.

### DETAILED DESCRIPTION

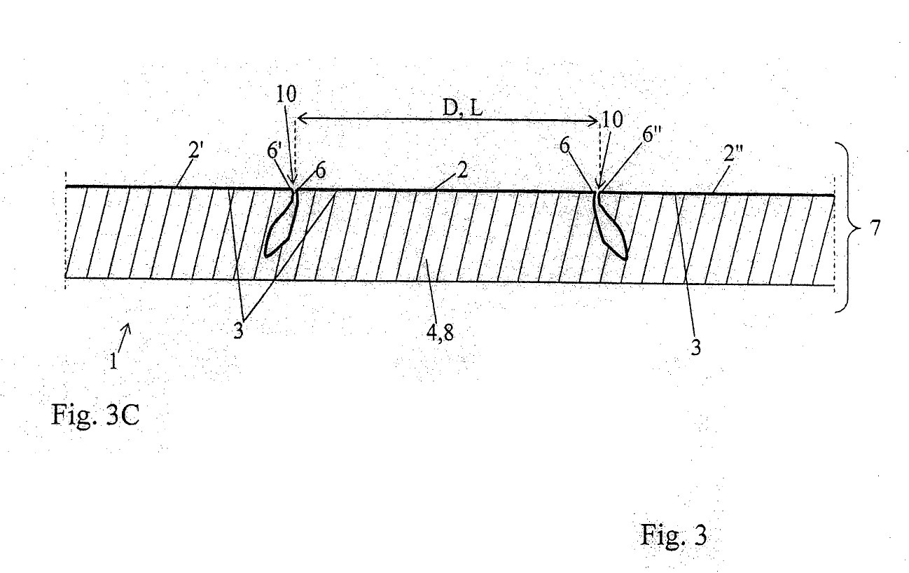

As show diagrammatically in FIGS. 3A-C and 4A-F of the accompanying drawings, the invention details a manufacturing process for a composite part 1 having at least two different appearances and/or feels in the region of at least two directly adjacent or contiguous apparent surface zones 2, 2′, 2″. This part 1 includes a skin 3 of a thermoplastic material in which one side forms the external and apparent face 3′ of said part 1. The opposing side or internal side of the skin 2 is covered by a material 4 forming the body of the part 1 (see FIG. 3C).

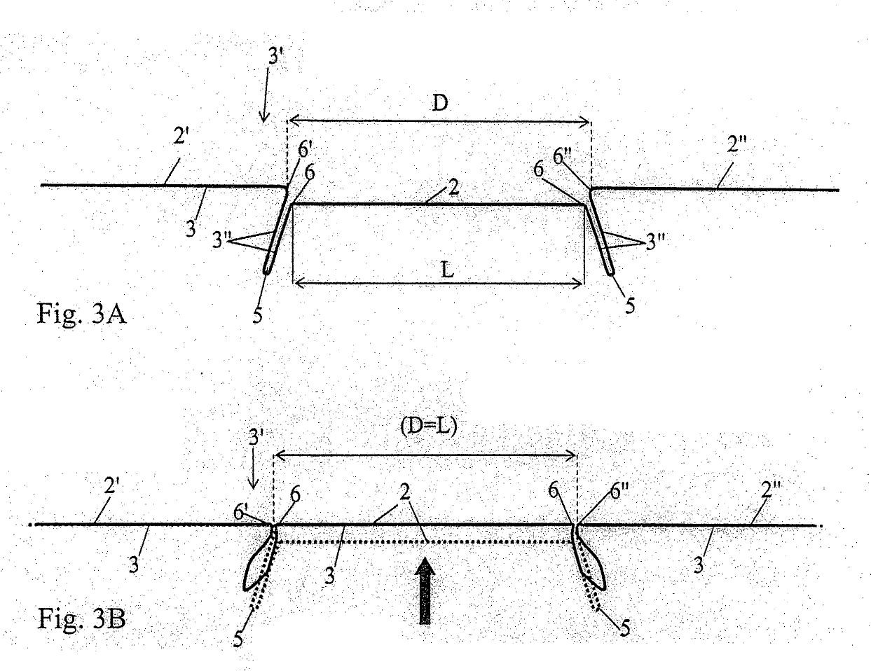

According to the invention, this process basically includes providing a skin 3 with at least two different appearances and/or feels in the region of the surface zones 2, 2′, 2″ concerned, providing a localized deformation in the form of a groove or recess 5 in the skin 3 at each interface between two surface zones 2, 2′, 2″ of different appearance and/or feel. Each deformation 5 defines a ridge 6, 6′, 6″ in the region of the edges opposite each pair of adjacent or contiguous surface zones 2, 2′; 2, 2″. One of the zones (zone 2 in FIG. 2A) of each pair of zones 2, 2′; 2, 2″ is recessed in relation to the other adjacent zone 2′ or 2″ of that pair. The treated and preformed skin 3 is arranged in a duplicate molding mold 7, which acts on the recessed surface zone 2 so as to displacing this zone 2 to bring, and optionally maintain, each ridge 6 of this zone 2 substantially in contact with (or in close proximity with) and flush with the or a corresponding ridge 6′, 6″ of the adjacent or contiguous surface zones 2′, 2″. This confers the skin 3 with its final form. The mold 7 is thereafter closed and duplicate molding of the skin 3 on the opposite side on the external face is performed. The aforementioned action is maintained until the duplicate molding material 8 is sufficiently set or solidified to retain the final form of the skin 3. Finally, the resulting composite part 1 is removed from said mold 7.

By incorporating different appearances in a single skin 3 and in a single piece, assembly operations that are tiresome and difficult to perform, in terms of finish, are avoided. Moreover, the aforementioned operating method guarantees the absence of interstices or spaces, of various shape or dimension, between two surface zones. The limit between two such zones is systematically reduced via this method to a line (with no apparent gap or interstice).

According to a first embodiment of the invention, the process may, with a view to obtaining the treated and preformed skin 3, consist more precisely of taking a raw skin 3, of generally flat structure, of performing one or more localized treatment operation(s) in the region of at least one, preferably each, surface zone 2, 2′, 2″ designed to confer on the treated surface zone(s) 2, 2′, 2″ a particular appearance and/or feel. The appearances being different from the one in the adjacent or contiguous surface zone(s) 2, 2′, 2″. The skin 3 is then thermoformed so as to create a localized deformation in the form of a groove or recess 5 at each interface between two different adjacent or contiguous surface zones 2, 2′; 2, 2″ and to position one zone 2 of each pair of adjacent and contiguous zones 2, 2′; 2, 2″ recessed in relation to the other zone 2′; 2″ of that pair. The defining line or separation band between two adjacent regions with different treatments is situated in the groove or recess 5 separating those surface zones 2, 2′ or 2, 2″.

According to a second preferred embodiment of the invention, the process may include of taking a raw skin 3, of generally flat structure and thermoforming the skin 3 so as to create localized deformations in the form of grooves or recesses 5 subdividing the apparent face 3′ of this skin 3 in at least two surface zones 2, 2′, 2″ and of positioning one zone 2, of each pair of adjacent or contiguous zones 2, 2′; 2, 2″ recessed in relation to the other zone 2′; 2″ of that pair. Thereafter one or more localized treatment(s) in the region of at least one, and preferably each, surface zone 2, 2′, 2″ is performed to confer on each of the surface zone(s) 2, 2′, 2″ a particular appearance and/or feel, the appearance being different from that of the adjacent or contiguous surface zone(s) 2, 2′, 2″.

In relation to this second embodiment, at least two variant implementations are possible. In one variant, certain ones of the treatment operations, and preferably all of them, are simultaneously done with thermoforming. If applicable, this can be done with the same tool and/or on the same station or the same machine 9. An alternative is to initially perform the thermoforming, and then perform the treatment operation or the different treatment operations (simultaneously or consecutively) for the or each of the surface zone(s) concerned 2, 2′, 2″.

Provision can be made according to the invention for portions of skin 3, in a single piece with different surface zones 2, 2′, 2″, to consist of materials with different characteristics, such as for example different colors, different natures, different compositions, different types of additives or different mechanical, physical and/or chemical properties.

Moreover, by way of non-limiting examples, the treatment operations aimed at conferring different appearances and/or feels on the surface zones 2, 2′, 2″ may be chosen from the group made up of thermal or thermo-mechanical surface treatments, surface impressions, modifications to the surface condition in terms of roughness, grain, flatness or friction coefficient and applications of additional superficial layers or coatings.

As shown in FIGS. 3A and 3B, and in accordance with an advantageous characteristic of the invention, the opposite ridges 6, 6′; 6, 6″ defining the edges of the opening of each groove or recess 5 are arranged, before their mutual leveling, substantially in alignment in the direction of displacement of the recessed surface zone 2 to confer on the skin 3 its final form. Preferably, the or each deformation in the form of a groove or recess 5 has a substantially profiled structure, of relatively small thickness and great depth, with generally a hairpin shape in transverse section, so as to define a blade- or band-shaped housing between two opposite flat skin walls, the mid-plane or plane of symmetry of each groove or recess 5 being inclined in relation to the vertical at the surface zones 2, 2′, 2″ concerned. FIGS. 3B and 3C show portions 3″ of the skin 3 forming the opposite side walls of each groove or recess 5 are deformed, while retaining their integrity, when the surface zone 2 that is recessed in relation to the adjacent surface zone(s) 2′, 2″ is leveled with respect thereto.

It will of course be understood that, in the context of the present invention, the skin 3 in a single piece may comprise either two surface zones with different appearances and/or feels separated by a single deformation, or a plurality of such zones separated in pairs, each time, by such a deformation. In its final shape these deformation(s) each reduced to a single line 10 in the region of the resulting composite part 1.

According to the illustrated embodiment, the skin 3 includes a central surface zone 2 with a first appearance and/or feel and two adjacent and contiguous side surface zones 2′ and 2″, situated on either side of said central surface zone 2 and having second appearances and/or feels, possibly identical.

According to the invention, the central surface zone 2 is, after preforming the skin 3, recessed in relation to the two other surface zones 2′ and 2″ and separated therefrom by slender, deep grooves or recesses 5 extending inclined in the direction of the recess of said central surface zone 2, beyond and in a direction moving away optionally therefrom. As seen in FIG. 3A, the central surface zone 2 has a transverse section width L substantially equal to the distance D separating the ridges 6′ and 6″ at the edges of the two side surface zones 2′ and 2″ situated on either side of said central surface zone 2. Thus, said central surface zone 2 will substantially entirely fills the free space separating said two side surface zones 2′ and 2″ after it is displaced to bring it on a level therewith (FIGS. 3B and 3C), at least in the region of its side ridges 6.

As will be appreciated, provision may possibly be made for only the central surface zone 2 to undergo a treatment operation modifying its appearance and/or feel, the two other zones 2′ and 2″ then retaining their original surfaces (conferred during manufacture of the skin 3).

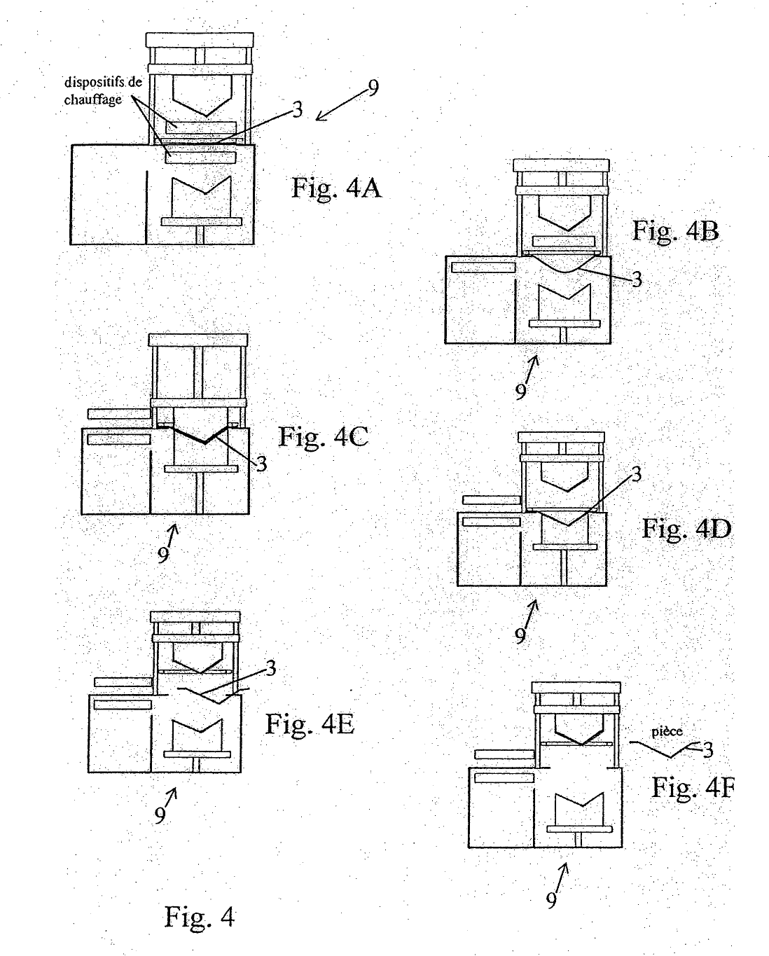

Preferably, and with a view to achieving optimal integration in the installation implementing the process, provision may be made for the preforming of the skin 3 and the treatment operation or operations of at least one or each surface zone 2, 2′, 2″ of this skin 3 to be performed on a single station or a single machine 9, preferably with a single tool or set of tools and in a single operation (FIG. 4).

In addition, depending on the configuration of the surface zones 2, 2′, 2″ and any aesthetic constraints or considerations that may be desired or required, two, or at least two among several, grooves or recesses 5 may meet in a single groove or recess in a longitudinal direction of the composite part 1.

Finally, according to a practical and advantageous implementation of the invention, illustrated in FIG. 4, the preforming of the skin 3, in the form of a leaf of a synthetic thermoplastic material, is produced by thermoforming under air pressure and by forming by negative vacuum.

Thus, as emerges from FIG. 4, the manufacturing stages of the preformed skin may, for example, be the following:

warming the plastic leaf forming the raw skin (FIG. 4A),

lowering the male section of the mold and preforming the skin by aspiration through this section (FIG. 4B),

lifting the female section of the mold and forming the skin by suction through said female section and simultaneously by air pressure on the opposite face of the skin through the male section. This operation allows the different grains or surface conditions to be reproduced on the apparent face of the skin (FIG. 4C),

the mold is then opened and the preformed skin is removed therefrom (FIGS. 4D to 4F).

After these skin preforming stages, the skin is arranged in a duplicate-molding mold which will confer the final shape of the part eliminating the interstices between the surface zones with different appearances and/or feels. More precisely, for an embodiment such as that illustrated in FIGS. 3A-C, the skin portion 3 corresponding to the surface zone 2 is pushed in the duplicate mold against the upper face of the mold and held in this position by aspiration under vacuum or electrostatically. The skin portions forming the interstice and the connection between two adjacent surface zones may be deformed without rupture so as to allow the surface zone 2 to be flush or level with the surface zones 2′ and 2″. Since the width L of the surface zone 2 is equal to the distance D separating the surface zones 2′ and 2″, the interstices between the adjacent zones 2, 2′ and 2, 2″ are reduced to zero or substantially zero.

The material 8 used for the duplicate molding and forming the body 4 of the part 1 may for example consist of a thermoplastic material, of a foaming material (for example polyurethane foam) or similar, of the same type or not, as the skin 3.

The invention also relates to a composite part formed such that it includes at least two different appearances and/or feels in the region of at least two directly adjacent or contiguous surface zones. The part further includes a thermoplastic skin that one side forms the external face of the part and on the other side includes a material covering the internal side of the skin and forming the body of the part. The composite part further includes at least two adjacent or contiguous surface zones 2, 2′; 2, 2″ with different appearances and/or feels, separated by a single line 10 of no thickness width or substantially no width. This is obtained by closing a separation groove or recess 5 during the process of manufacturing the part 1 as described above.

Thus, with the aid of the invention, it is possible to overcome the drawbacks and limitations of the state of the art.

In fact, by using only a single skin and incorporating the production of the interfaces or limits between skin zones of different appearance and/or feel in the process of manufacturing said skin (in the form of a groove formed by the forming tool for this skin, it is possible to reduce with certainty the interstices between adjacent zones to a single line. Advantageously, the invention uses the same skin for different functions (appearances, feels, surface treatments, etc.) and the same tool to produce these different zones. The tool used comprises special means of producing the groove(s) or recess(es) separating the different appearances and/or feels of the skin and allowing the limits between them to be hidden.

Of course, the invention is not limited to the embodiments described and of which only one is illustrated in the accompanying drawings. Modifications are possible, particularly from the point of view of the composition of the various elements and by substitution of technical equivalents, without thereby departing from the scope of protection of the invention.

1. A process for manufacturing a composite part having at least two different appearances and/or feels in the region of at least two directly adjacent or contiguous apparent surface zones;
providing a skin having an external face;
defining a groove in the skin to define an interstice between two adjacent surface zones whereby each surface zone includes an edge generally opposite the adjacent surface zones;
locating one of the surface zones set back from the other of the surface zones;
displacing the set back one of the surface zones such that it is flush with the other of the surface zones and the edges of each of the surface zone are in contact with one another; and
forming a first appearance in a first portion of the skin.

2. The method of claim 1 wherein the steps of forming the first appearance occurs before the step of forming the groove.

3. The method of claim 1 wherein the steps of forming the first appearance occurs after the step of forming the groove.

4. The method of claim 1 further comprising the step of forming a second appearance in a second portion of the skin.

5. The method of claim 1 wherein the steps of forming the first and second appearances occur simultaneously.

6. The method of claim 4 wherein the steps of forming the first and second appearances occur sequentially.

7. The method of claim 1 further comprising the steps of:
after the displacing step, molding a body of material to the skin on an internal face located opposite the external face to form a composite part; and
setting the body of material so as to provide a final shape to the composite part.

8. The method of claim 7 wherein the displacing, molding and setting steps are performed in a single molding station.

9. The method of claim 7 wherein the displacing, forming, molding and setting steps are performed in a single molding station.

10. The method of claim 1 wherein the displacing and forming steps are performed in a single molding station.

11. The method of claim 1 wherein the forming of the first appearance result in an area of demarcation being formed in the skin, the area of demarcation being located within the groove after the defining step.

12. The method of claim 1 wherein the step of defining the groove includes thermoforming of the skin.

13. The method of claim 12 wherein the step of thermoforming the skin is performed simultaneously with the step of forming the first appearance.

14. The method of claim 12 wherein the step of thermoforming the skin is performed simultaneously with the steps of forming the first appearance and forming a second appearance in the skin.

15. The method of claim 1 wherein the step of forming the first appearance is chose from the group of thermal surface treatments, thermo-mechanical surface treatments, surface impression, modification to surface condition in terms of roughness, grain, flatness or friction coefficient, and application of superficial layers or coatings.

16. The method of claim 1 further comprising the step of arranging the edges of the adjacent surface zones, before the displacing step, in substantial alignment in the direction of displacing.

17. The method of claim 1 wherein the defining step defines a groove with a depth greater than a wall thickness of the skin forming the groove and oriented at an incline relative to a line normal to the surface zones.

18. The method of claim 1 wherein during the displacing step the portion of the skin defining the groove maintains its integrity.

19. The method of claim 1 further comprising the step of forming a second appearance in portions of the skin located around the first portion.

20. The method of claim 1 wherein the set back one of the surface zones is a central surface zone defined within the other of the surface zones and has a width substantially equal to a width defined between opposing edges of the other of the surface zones.

21. The method of claim 20 wherein the forming of the first appearance is performed on the central surface zone.

22. A composite part formed by the method of claim 1.
